(19) United States
(12) Patent Application Publication
(10) Pub. No.: US 2026/0359030 A1
(43) Pub. Date: Nov. 12, 2026

(54) Application Programming Interface Stratification and Autonomous Remediation System

(71) Applicant: Bank of America Corporation, Charlotte, NC (US)

(72) Inventors: Pratik Govind Sidam, Mumbai (IN); Jharna Chander Idnani, Mumbai (IN); Durga Prasad Kutthumolu, Hyderabad (IN); Rustum Mohiddin Mohammad, Hyderabad (IN)

(21) Appl. No.: 19/200,958

(22) Filed: May 7, 2025

(51) Int. Cl. G06F 8/65; G06F 8/71

(52) U.S. Cl. CPC G06F 8/65; G06F 8/71

(57) ABSTRACT

Various aspects of the disclosure relate to computer hardware and software for managing API operations via machine learning analysis of API usage patterns and automating API issue detection and remediation activities to reduce downtime and improve API use efficiencies. The application programming interface stratification and autonomous remediation system enables automated inventory creation, streamlines data separation and/or protections, facilitates the retirement of outdated API versions, identifies APIs that require access restriction based on usage patterns, and identifies security issues and/or vulnerabilities that can be automatically resolved. The application programming interface stratification and autonomous remediation system a data ingestion layer, a learning model for metadata schema clustering, an obsolete data driven API mesh, a real-time threat intelligence platform, and API re-scripting generator, and a policy enforcement engine.

### BACKGROUND

Large organizations, such as financial institutions and other large enterprise organizations, may provide many different products and/or services. To support these complex and large-scale operations, a large organization may own, operate, and/or maintain many different computer systems that service different internal users and/or external users in connection with different products and services. In addition, some computer systems internal to the organization may be configured to exchange information with computer systems external to the organization so as to provide and/or support different products and services offered by the organization.

As a result of the complexity associated with the operations of a large organization and its computer systems, it may be difficult for such an organization, such as a financial institution, to manage its computer systems efficiently, effectively, securely, and uniformly, and particularly manage how internal computer systems exchange information with external computer systems in providing and/or supporting different products and services offered by the organization. In the current digital era, businesses heavily rely on the use of application programming interfaces (APIs) for various operations and to integrate same or similar functionality into diverse systems. Efficiently managing these APIs is crucial but challenging due to the complexity and the volume of APIs in use. Current management methods are inefficient, time-consuming, and/or error prone, which leads to operational inefficiencies, broken links, and potential security vulnerabilities.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary presents some concepts of the disclosure in a simplified form as a prelude to the description below.

Aspects of the disclosure relate to computer systems that provide effective, efficient, scalable, and convenient ways of securely and uniformly managing how internal computer systems exchange information with external computer systems to provide and/or support different products and services offered by an organization (e.g., a financial institution, and the like).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes enhancing autonomous API management operations via analysis of API specifications, user behavior and/or access patterns. Aspects of the disclosure relate to computer hardware and software. In particular, one or more aspects of the disclosure generally relate to computer hardware and software for managing API operations via machine learning analysis of API usage patterns and automating API issue detection and remediation activities to reduce downtime and improve API use efficiencies.

As the number of APIs grows, managing and maintaining an up-to-date inventory of application programming interfaces, protecting the security of data appropriately, retiring outdated versions, and setting access restrictions based on a number of factors has become more cumbersome. Such tasks are critical for optimizing API operational performance, maintaining compliance with both business rules and technological features and/or limitations of enterprise hardware and software, and protecting sensitive information. The current reliance on manual processes for API management means business often struggle with incomplete documentation, inconsistent application of policies and delayed responses to security threats. Such inefficiencies can result in significant operational disruptions and increased costs. For example, outdated and/or inactive versions of application programming interfaces may be implemented in different operational platforms and/or application computing systems, so that operational efficiencies are reduced as conflicting operations of included functionality may reduce access and/or communication speeds or cause applications to crash. To address these challenges, a pressing need has been recognized for an intelligent API management system that leverages advanced technologies to automate and improve operations of key API management tasks. Such a system enables automated inventory creation, streamlines data separation and/or protections, facilitates the retirement of outdated API versions, identifies APIs that require access restriction based on usage patterns, and identifies security issues and/or vulnerabilities that can be automatically resolved. Additionally, identifying viable and obsolete endpoints, understanding usage patterns, and ensuring data security require significant effort. By automating these processes, enterprise organizations can achieve greater accuracy, efficiency, and security in their API management operations, ultimately enhancing operational capabilities and reducing security risks to vulnerabilities.

The application programming interface stratification and autonomous remediation system is an intelligent system that leverages machine learning and advanced data processing techniques to automate and optimize API management tasks. The system comprises several integrated components that work together to process and analyze API documentation, existing codebase, database, logs to detect and automatically resolve API inventory issues. Aspects of the application programming interface stratification and autonomous remediation system include a data ingestion layer, a learning model for metadata schema clustering, an obsolete data driven API mesh, a real-time threat intelligence platform, and API re-scripting generator, and a policy enforcement engine. The data ingestion layer may be responsible for collecting, importing, and/or processing data from various sources. The learning model for metadata schema clustering may create clusters of metadata and APIs based on data one or more of sensitivity, operational importance, and frequency of access. The obsolete data driven API mesh may comprise a mesh with parent-child dependencies based on the clustering results. The real-time threat intelligence platform may comprise a learning model that operates using real-time feeds associated with API usage to detect and identify issues according to recent security threats and/or security vulnerabilities and may separate APIs (e.g., quarantine) within the API mesh. The API re-scripting generator may process APIs separated within the mesh to generate code to update and/or otherwise resolve API issues due to software errors. The policy enforcement engine may process a rule set to identify outdated versions and/or obsolete APIs based on different security and/or operational policies that may be applied inside the API mesh.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A shows an illustrative computing environment for automating and optimizing API management functionalities, in accordance with one or more aspects described herein;

FIG. 1B shows an illustrative computing platform enabled for automating and optimizing API management functionalities, in accordance with one or more aspects described herein; and

FIGS. 2A and 2B show an illustrative architecture diagram for an API stratification and autonomous remediation system, in accordance with one or more aspects described herein;

FIG. 3 shows portions of an illustrative technical flow diagram of an API stratification and autonomous remediation system in accordance with one or more aspects described herein; and

FIG. 4 shows portions of an illustrative technical flow diagram of an API stratification and autonomous remediation system in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As used throughout this disclosure, computer-executable “software and data” can include one or more: algorithms, applications, application program interfaces (APIs), attachments, big data, daemons, emails, encryptions, databases, datasets, drivers, data structures, file systems or distributed file systems, firmware, graphical user interfaces, images, instructions, machine learning (e.g., supervised, semi-supervised, reinforcement, and unsupervised), middleware, modules, objects, operating systems, processes, protocols, programs, scripts, tools, and utilities. The computer-executable software and data is on tangible, computer-readable memory (local, in network-attached storage, or remote), can be stored in volatile or non-volatile memory, and can operate autonomously, on-demand, on a schedule, and/or spontaneously.

“Computer machines” can include one or more: general-purpose or special-purpose network-accessible administrative computers, clusters, computing devices, computing platforms, desktop computers, distributed systems, enterprise computers, laptop or notebook computers, primary node computers, nodes, personal computers, portable electronic devices, servers, node computers, smart devices, tablets, and/or workstations, which have one or more microprocessors or executors for executing or accessing the computer-executable software and data. References to computer machines and names of devices within this definition are used interchangeably in this specification and are not considered limiting or exclusive to only a specific type of device. Instead, references in this disclosure to computer machines and the like are to be interpreted broadly as understood by skilled artisans. Further, as used in this specification, computer machines also include all hardware and components typically contained therein such as, for example, processors, executors, cores, volatile and non-volatile memories, communication interfaces, etc.

Computer “networks” can include one or more local area networks (LANs), wide area networks (WANs), the Internet, wireless networks, digital subscriber line (DSL) networks, frame relay networks, asynchronous transfer mode (ATM) networks, virtual private networks (VPN), or any combination of the same. Networks also include associated “network equipment” such as access points, ethernet adaptors (physical and wireless), firewalls, hubs, modems, routers, and/or switches located inside the network and/or on its periphery, and software executing on the foregoing.

The above-described examples and arrangements are merely some examples of arrangements in which the systems described herein may be used. Various other arrangements employing aspects described herein may be used without departing from the innovative concepts described for systems and methods for stratification and autonomous remediation of inventory of APIs using machine learning.

In the current digital era, the, all the businesses are heavily relying on the use of application programming interfaces (APIs) that provide interfaces for various operations and integrate driver systems. Efficient management of these APIs is crucial for proper operation of all applications within an enterprise network, but challenging due to programming complexity and the volume of APIs in use. Currently there are manual methods that are often used to manage And document these APIs. These processes can be time consuming and prone to errors, thus causing errors, inefficiencies, and potential security vulnerabilities.

The main challenges for efficient API management as the number of APIs grow, is maintaining an up to date inventory and/or separately the data appropriately. Out-dated versions and setting access restrictions become more cumbersome. These tasks are critical to optimize performance, maintain compliance, and protect sensitive information. The current reliance on manual process for API management means business often struggle with incomplete documentation. Inconsistent application of policies and delayed responses to security threats, can result in insignificant operational disruptions and, hence, increased costs.

To address these challenges, a need has been recognized for an intelligent system that leverages advanced technology to automate key API management tasks. Such a system enables automated inventory creation, streamlined data separation, facilitates and/or performs the required retirement of outdated API versions, manages APIs that require access restriction based on the usage patterns and/or address and resolve the new security issues which require fixes.

The application programming interface stratification and autonomous remediation system may identify viable and obsolete endpoints to identify and analyze usage patterns to ensure data security. With the autonomous performance of these processes by the application programming interface stratification and autonomous remediation system, the enterprise network becomes more accurate, more efficient, and by becoming more secure and efficient in the API management practices, ultimately enhancing operational capabilities and reducing inefficiencies and security vulnerabilities.

The application programming interface stratification and autonomous remediation system parses and cleans data from API documentation, existing codebase, database, logs, analytics tools extracting endpoints and metadata. To do so, the application programming interface stratification and autonomous remediation system uses a machine learning (ML) model that is trained on preprocessed data to create clusters of metadata and APIs based on analysis of data sensitivity, operational importance of the data and frequency of access. An integral part of the application programming interface stratification and autonomous remediation system is the obsolete data driven API mesh that utilizes parent-child dependencies based on the clustering results. The application programming interface stratification and autonomous remediation system employs a real-time threat intelligence platform learning model that processes real-time feeds to detect issues according to recent security threats and/or vulnerabilities and to quarantine APIs in the API mesh such that the employs dynamic segregation of APIs. The application programming interface stratification and autonomous remediation system further includes a real-time threat intelligence platform to continually evaluate and/or categorize APIs based on the latest threat intelligence adjustment factor calculations performed within the API mesh. The application programming interface stratification and autonomous remediation system may automatically adjust security policies, monitoring levels, and routing decisions within the API mesh according to the current classification of each API. The application programming interface stratification and autonomous remediation system employs an API re-scripting generator that automatically updates and/or resolves errors and vulnerabilities or otherAPI issues that require code fixes. The application programming interface stratification and autonomous remediation system includes a policy enforcement module to identify outdated APIs, where different security and operational policies may be applied as necessary. As such, the application programming interface stratification and autonomous remediation system maintains an updated and efficient API inventory.

The application programming interface stratification and autonomous remediation system seeks to enhance API management efficiency by creating comprehensive inventory. This involves using advanced data processing and machine learning techniques to analyze API documentation, user behavior, and access patterns associated with each API active and/or inactive, within the enterprise network. By identifying and fixing sensitive endpoints and retiring outdated API versions, the enterprise organization can significantly reduce the possibility of data breaches and/or susceptibility to security vulnerabilities and better ensures compliance with regulatory standards. A well-maintained API inventory streamlines operations within the Enterprise network and thus reduces time and technical resources spent on maintaining outdated APIs. The application programming interface stratification and autonomous remediation system ensures only the most current and secure APIs are in use, and as such, can provide a more reliable and faster service to the users of the API functionalities, thus enhancing an overall performance and trust with the digital services provided via the enterprise network. The application programming interface stratification and autonomous remediation system provides continuous monitoring and automatic issue remediation ensure secure API operations. By automating API issue detection and remediation, the application programming interface stratification and autonomous remediation system reduces downtime and maintenance cost. Additionally, ensures adherence to data protection policies and rules by classifying and managing sensitive APIs appropriately, such as by performing efficient management of API lifecycles, including deprecations of outdated APIs. The application programming interface stratification and autonomous remediation system is also capable of handling large volumes of API calls and data.

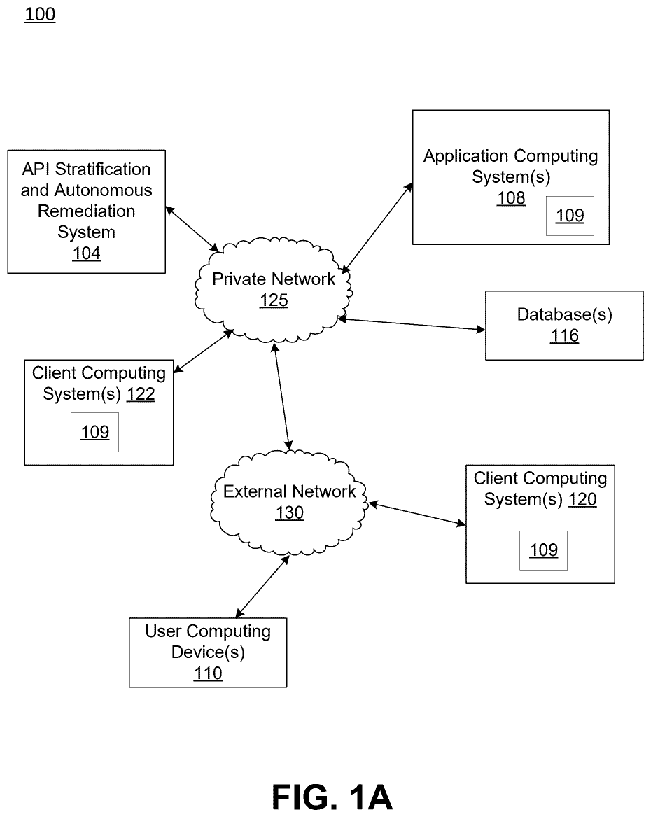

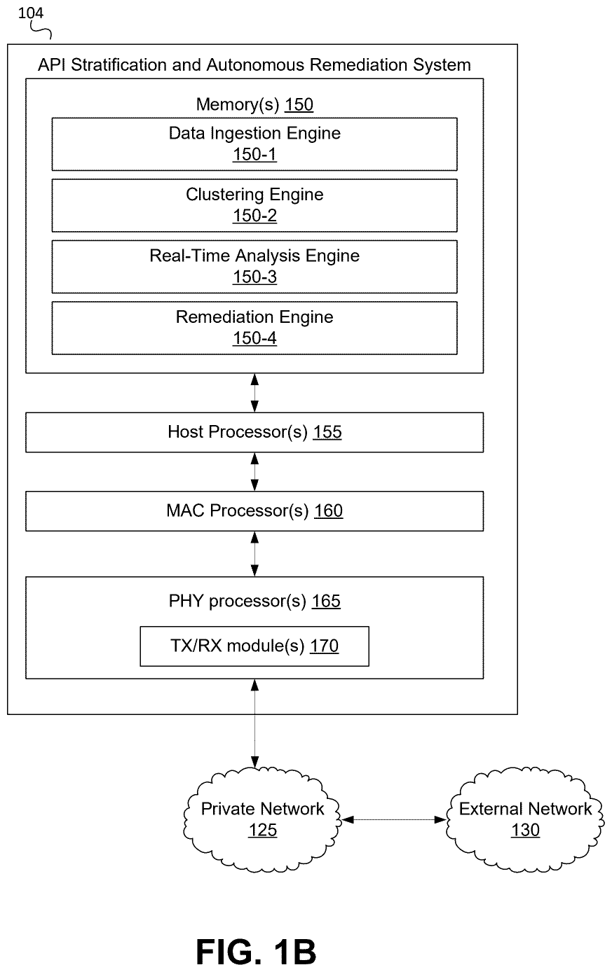

FIG. 1A shows an illustrative computing environment 100 for automating and optimizing API management functionalities, in accordance with one or more arrangements. The computing environment 100 may comprise one or more devices (e.g., computer systems, communication devices, and the like). The computing environment 100 may comprise, for example, an API stratification and autonomous remediation system 104, one or more application computing systems 108, one or more client computing systems 122, and/or one or more database(s) 116. The one or more of the devices and/or systems, may be linked over a private network 125 associated with an enterprise organization (e.g., a financial institution, a business organization, an educational institution, a governmental organization and the like). The computing environment 100 may additionally comprise one or more client computing systems 120 and one or more user devices 110 connected, via a public network 130, to the devices in the private network 125. The devices in the computing environment 100 may transmit/exchange/share information via hardware and/or software interfaces using one or more communication protocols. The communication protocols may be any wired communication protocol(s), wireless communication protocol(s), one or more protocols corresponding to one or more layers in the Open Systems Interconnection (OSI) model (e.g., local area network (LAN) protocol, an Institution of Electrical and Electronics Engineers (IEEE) 802.11 WIFI protocol, a 3^{rd} Generation Partnership Project (3GPP) cellular protocol, a hypertext transfer protocol (HTTP), etc.). While FIG. 1A shows the API stratification and autonomous remediation system 104 as a separate computing system, the API stratification and autonomous remediation system 104 may be integrated into one or more different computing systems, such as the application computing systems.

The API stratification and autonomous remediation system 104 may comprise one or more computing devices and/or other computer components (e.g., processors, memories, communication interfaces) configured to perform one or more functions as described herein. Further details associated with the architecture of the API stratification and autonomous remediation system 104 are described with reference to FIG. 1B.

The application computing systems 108 and/or the client computing systems 122 may comprise one or more computing devices and/or other computer components (e.g., processors, memories, communication interfaces). In addition, the application computing systems 108 and/or the client computing systems 122 may be configured to host, execute, and/or otherwise provide one or more enterprise applications. In some cases, the application computing systems 108 may host one or more services 109 configured facilitate operations requested through one or more API calls, such as data retrieval and/or initiating processing of specified functionality. In some cases, the client computing systems 122 may be configured to communicate with one or more of the application computing systems 108 such as via direct communications and/or API function calls and the services 109. In an arrangement where the private network 125 is associated with a financial institution (e.g., a bank), the application computing systems 108 may be configured, for example, to host, execute, and/or otherwise provide one or more transaction processing programs, such as an online banking application, fund transfer applications, and/or other programs associated with the financial institution. The client computing systems 122 and/or the application computing systems 108 may comprise various servers and/or databases that store and/or otherwise maintain account information, such as financial account information including account balances, transaction history, account owner information, and/or other information. In addition, the client computing systems 122 and/or the application computing systems 108 may process and/or otherwise execute transactions on specific accounts based on commands and/or other information received from other computer systems comprising the computing environment 100. In some cases, one or more of the client computing systems 122 and/or the application computing systems 108 may be configured, for example, to host, execute, and/or otherwise provide one or more transaction processing programs, such as electronic fund transfer applications, online loan processing applications, and/or other programs associated with the financial institution.

The application computing systems 108 may be one or more host devices (e.g., a workstation, a server, and the like) or mobile computing devices (e.g., smartphone, tablet). In addition, an application computing systems 108 may be linked to and/or operated by a specific enterprise user (who may, for example, be an employee or other affiliate of the enterprise organization) who may have administrative privileges to perform various operations within the private network 125. In some cases, the application computing systems 108 may be capable of performing one or more layers of user identification based on one or more different user verification technologies including, but not limited to, password protection, pass phrase identification, biometric identification, voice recognition, facial recognition and/or the like. In some cases, a first level of user identification may be used, for example, for logging into an application or a web server and a second level of user identification may be used to enable certain activities and/or activate certain access rights.

The client computing systems 120 may comprise one or more computing devices and/or other computer components (e.g., processors, memories, communication interfaces). The client computing systems 120 may be configured, for example, to host, execute, and/or otherwise provide one or more transaction processing programs, such as goods ordering applications, electronic fund transfer applications, online loan processing applications, and/or other programs associated with providing a product or service to a user. With reference to the example where the client computing systems 120 is for processing an electronic exchange of goods and/or services. The client computing systems 120 may be associated with a specific goods purchasing activity, such as purchasing a vehicle, transferring title of real estate may perform communicate with one or more other platforms within the client computing systems 120. In some cases, the client computing systems 120 may integrate API calls to request data, initiate functionality, or otherwise communicate with the one or more application computing systems 108, such as via the services 109. For example, the services 109 may be configured to facilitate data communications (e.g., data gathering functions, data writing functions, and the like) between the client computing systems 120 and the one or more application computing systems 108.

The user device(s) 110 may be computing devices (e.g., desktop computers, laptop computers) or mobile computing device (e.g., smartphones, tablets) connected to the network 125. The user device(s) 110 may be configured to enable the user to access the various functionalities provided by the devices, applications, and/or systems in the network 125.

The database(s) 116 may comprise one or more computer-readable memories storing information that may be used by the API stratification and autonomous remediation system 104. For example, the database(s) 116 may store API code of an API to be analyzed and/or upgraded, API use information, API operational information, and the like. In an arrangement, the database(s) 116 may be used for other purposes as described herein. In some cases, the client computing systems 120 may write data or read data to the database(s) 116 via the services 109.

In one or more arrangements, the API stratification and autonomous remediation system 104, the application computing systems 108, the client computing systems 122, the client computing systems 120, the user devices 110, and/or the other devices/systems in the computing environment 100 may be any type of computing device capable of receiving input via a user interface, and communicating the received input to one or more other computing devices in the computing environment 100. For example, the API stratification and autonomous remediation system 104, the application computing systems 108, the client computing systems 122, the client computing systems 120, the user devices 110, and/or the other devices/systems in the computing environment 100 may, in some instances, be and/or include server computers, desktop computers, laptop computers, tablet computers, smart phones, wearable devices, or the like that may comprised of one or more processors, memories, communication interfaces, storage devices, and/or other components. Any and/or all of the the API stratification and autonomous remediation system 104, the application computing systems 108, the client computing systems 122, the client computing systems 120, the user devices 110, and/or the other devices/systems in the computing environment 100 may, in some instances, be and/or comprise special-purpose computing devices configured to perform specific functions.

FIG. 1B shows an illustrative API stratification and autonomous remediation system 104 i accordance with one or more examples described herein. The API stratification and autonomous remediation system 104 may be a stand-alone device and/or may at least be partial integrated with the API stratification and autonomous remediation system 104 may comprise one or more of host processor(s) 155, medium access control (MAC) processor(s) 160, physical layer (PHY) processor(s) 165, transmit/receive (TX/RX) module(s) 170, memory 150, and/or the like. One or more data buses may interconnect host processor(s) 155, MAC processor(s) 160, PHY processor(s) 165, and/or Tx/Rx module(s) 170, and/or memory 150. The API stratification and autonomous remediation system 104 may be implemented using one or more integrated circuits (ICs), software, or a combination thereof, configured to operate as discussed below. The host processor(s) 155, the MAC processor(s) 160, and the PHY processor(s) 165 may be implemented, at least partially, on a single IC or multiple ICs. The memory 150 may be any memory such as a random-access memory (RAM), a read-only memory (ROM), a flash memory, or any other electronically readable memory, or the like.

Messages transmitted from and received at devices in the computing environment 100 may be encoded in one or more MAC data units and/or PHY data units. The MAC processor(s) 160 and/or the PHY processor(s) 165 of the API stratification and autonomous remediation system 104 may be configured to generate data units, and process received data units, that conform to any suitable wired and/or wireless communication protocol. For example, the MAC processor(s) 160 may be configured to implement MAC layer functions, and the PHY processor(s) 165 may be configured to implement PHY layer functions corresponding to the communication protocol. The MAC processor(s) 160 may, for example, generate MAC data units (e.g., MAC protocol data units (MPDUs)), and forward the MAC data units to the PHY processor(s) 165. The PHY processor(s) 165 may, for example, generate PHY data units (e.g., PHY protocol data units (PPDUs)) based on the MAC data units. The generated PHY data units may be transmitted via the TX/RX module(s) 170 over the private network 125. Similarly, the PHY processor(s) 165 may receive PHY data units from the TX/RX module(s) 165, extract MAC data units encapsulated within the PHY data units, and forward the extracted MAC data units to the MAC processor(s). The MAC processor(s) 160 may then process the MAC data units as forwarded by the PHY processor(s) 165.

One or more processors (e.g., the host processor(s) 155, the MAC processor(s) 160, the PHY processor(s) 165, and/or the like) of the API stratification and autonomous remediation system 104 may be configured to execute machine readable instructions stored in memory 150. The memory 150 may comprise (i) one or more program modules/engines having instructions that when executed by the one or more processors cause the API stratification and autonomous remediation system 104 to perform one or more functions described herein and/or (ii) one or more databases that may store and/or otherwise maintain information which may be used by the one or more program modules/engines and/or the one or more processors. The one or more program modules/engines and/or databases may be stored by and/or maintained in different memory units of the API stratification and autonomous remediation system 104 and/or by different computing devices that may form and/or otherwise make up the API stratification and autonomous remediation system 104. For example, the memory 150 may have, store, and/or comprise a data ingestion engine 150-1, a clustering engine 150-2, a real-time analysis engine 150-3, a remediation engine 150-4, and/or the like. The data ingestion engine 150-1may have instructions that direct and/or cause the API stratification and autonomous remediation system 104 to perform one or more operations associated with collecting, importing and processing data from various sources, and the like. The clustering engine 150-2 may have instructions that may cause the API stratification and autonomous remediation system 104 to create clusters of metadata and APIs based on data sensitivity, operational Importance and frequency of access. The real-time analysis engine 150-3 may have instructions that may cause the API stratification and autonomous remediation system 104 to utilize a learning model that uses real-time feeds to detect issues according to recent threats and quarantine APIs in the API mesh. The remediation engine 150-4 may have instructions that may cause the API stratification and autonomous remediation system 104 to automatically updates and fix the API issues that require code fixes and/or enforce operational policies.

While FIG. 1A illustrates the API stratification and autonomous remediation system 104, the API stratification and autonomous remediation system 104, and/or the application computing systems 108, as being separate elements connected in the private network 125, in one or more other arrangements, functions of one or more of the above may be integrated in a single device/network of devices. For example, elements in the API stratification and autonomous remediation system 104 (e.g., host processor(s) 155, memory(s) 150, MAC processor(s) 160, PHY processor(s) 165, TX/RX module(s) 170, and/or one or more program/modules stored in memory(s) 150) may share hardware and software elements with and corresponding to, for example, the API stratification and autonomous remediation system 104, and/or the application computing systems 108.

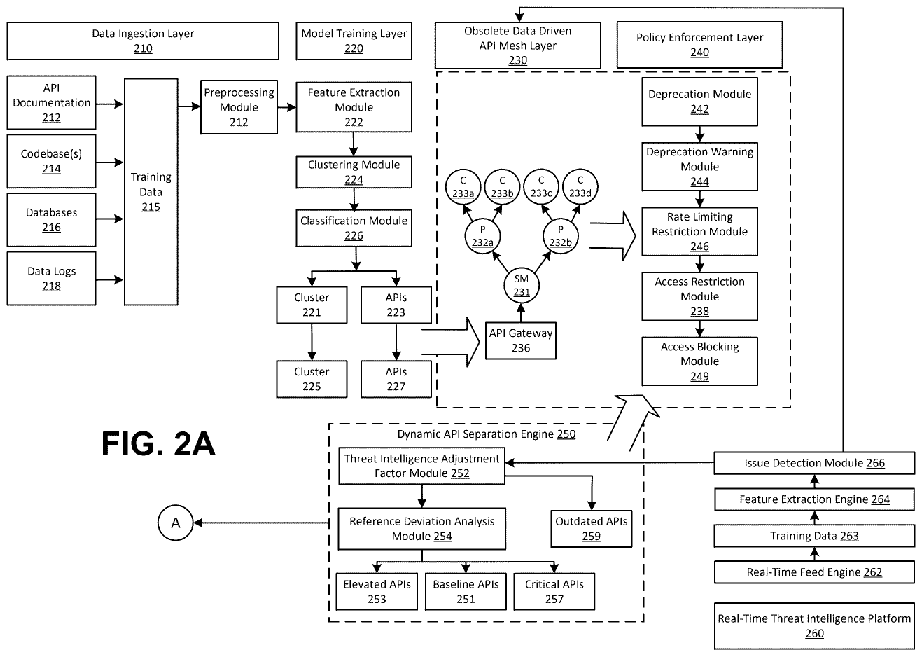

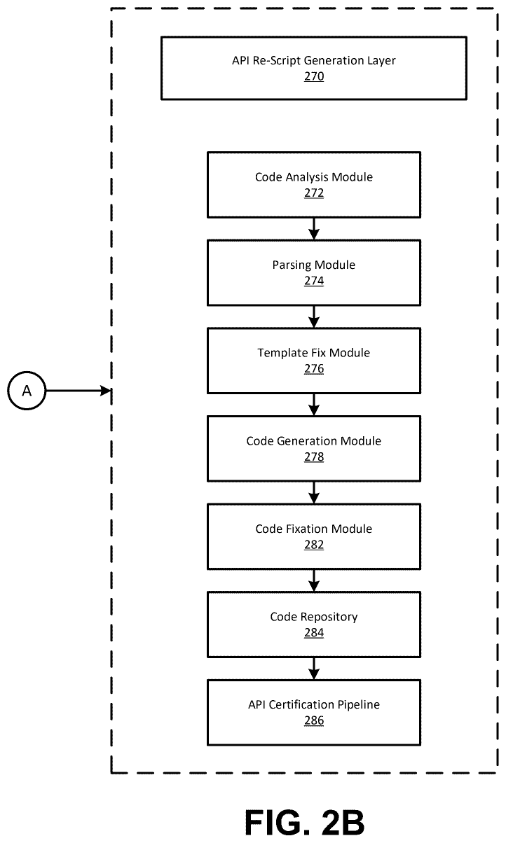

FIGS. 2A and 2B show an illustrative architecture diagram for an API stratification and autonomous remediation system, in accordance with one or more aspects described herein. The enterprise network includes many systems that may utilize similar or same processes for different applications, products and/or services, where system efficiencies may be improved through use of shared functionality, such as by using APIs and sharing data and/or processing capability via the APIs. Because functionality may be improved or modified via updates in an underlying system receiving an API function call and/or an application initiating the API function call, changes to one or more involved systems necessitate updates the APIs depending upon the newest functionality, identified vulnerabilities and/or retirement of any outdated API or API functionality.

The API stratification and autonomous remediation system 104 may include multiple layers, such as a data ingestion layer 210, a model training layer 220, an obsolete data driven API mesh layer 230, a policy enforcement layer 240 that may include a dynamic API separation engine 250, a real-time threat intelligence platform layer 260, and an API re-script generation layer 270. The data ingestion layer 210 aggregates data from multiple sources to train an AI learning model that creates clusters of metadata and APIs based on data sensitivity, operational importance, and frequency of access characteristics of each API. For example, a data ingestion engine may receive or retrieve data from multiple data sources (e.g., one or more API documentation data repositories 212, one or more API code base data repositories 214, one or more databases 216 storing operational and/or use data corresponding to each API in use, previously used by, and/or in development for use with the enterprise network applications and/or services, and one or more data logs corresponding to use, security vulnerabilities and/or threats, and/or operational errors corresponding to use or operation of each API.

All or a portion of the aggregated data may be assembled into a training data set 215 and preprocessed for use by AI analysis model via the preprocessing module 217. In the model training layer 220, the preprocessed training data may be fed to a feature extraction module 222 to extract relevant features from the pre-processed data, group APIs based on these features, such as by a clustering module 224 and to further classify these clusters by a classification module 226 based on data sensitivity, operational importance, and frequency of. access. to form clusters of metadata (e.g., cluster 221, cluster 225) and/or clusters of APIs (e.g., API cluster 223, API cluster 227), and/or clusters of a combination of APIs and API metadata.

The obsolete data driven API mesh layer 230 may receive the data to further provide a hierarchical representation of a parent-child dependencies of APIs based on the clustering results. The API mesh architecture provides a parent-child dependency architecture, where all APIs are registered in the mesh according to the clustering data and a dependency management system that manages dependencies and other relationships between different APIs. The real-time threat intelligence platform 260 may utilize the learning model that uses the real-time network security, threat and/or vulnerability feeds to detect issues according to recent threats and segregate or otherwise separate APIs in the API mesh. The real-time threat intelligence platform 260 collects all the aggregate logs, events and alerts related to API usage and outlier activities, and integrates real-time feeds with the real-time threat intelligence platform 260. For example, a real-time feed engine 262 processes the real-time data feeds to generate training data 263 for the learning model, where the feature extraction engine 264, based on the model, extracts features associated with each of the APIs that may be problematic. An issue detection module 256 analyzes the extracted features to identify issues associated with one or more of the APIs and classify the issues (or lack of issues) for use by the dynamic API separation engine 250. The feature extraction engine 264 may extract outlier activity, threat level associated with current threats, vulnerabilities, and/or previous incidents, along with authentication of the APIs, security levels associated with each API (e.g., a level of access to sensitive data, and the like) and/or identify outdated versions of the APIs that are no longer in use.

In some cases, the model may detect or otherwise identify unusual patterns in Detects unusual patterns in API behavior and/or recognize patterns of potential issues from the threat intelligence feed feeds. Once an issue is detected, the system documents the specific details, the type of issue, affected endpoint(s), and suggest possible fixes. This information may be associated with a data record corresponding to the associated API, API cluster, and/or API version. For example, a threat intelligence adjustment factor module 252 may assign an adjustment factor to increase and/or decrease an associated classification level based on an identified risk (or potential risk) to the enterprise network corresponding to the API, the available API functionality, information corresponding to systems and/or data accessible via the API function calls, and/or whether the API or API version is obsolete or a previous version. The dynamic API separation engine 250 may perform dynamic segregation of the APIs and separates API according to the operations of the reference deviation analysis module 254 to identify critical deviated APIs 257, elevated deviated APIs 253, baseline deviation APIs 251, and/or outdated APIs 259.

Once all these issues and associated APIs are segregated, the dynamic API separation engine 250 will pass according to, a criticalness of an issue and/or a criticalness of a particular API has to enterprise computing system operations, to the API rescript generator 270. The API rescript generator processes the API code to identify issues and automatically update or otherwise fix the identified issues with each API that requires a code fix. The API rescript generation layer (e.g., an API re-script generator) may include a code analysis module 272 and a parsing module 274 to process API code to identify issues based on information received regarding threats and/or vulnerabilities. In some cases, this analysis and parsing may identify efficiencies or other operational enhancements that may improve operational performance. Template-based fixes may be generated by a template fix module 276 based on one or more function templates and/or functionality templates that may be centrally managed such that improved operational efficiencies or updates to enterprise network architecture, hardware, and/or software can be automatically included in the template to allow real-time updates to all affected APIs. A code generation module 278 and a code fixation module 282 may further generate code to fix identified issues. In some cases, the code generation may modify individual functions to improve operational functionality. In some cases, code fixation may involve changing API endpoints, modifying request validation logic, and/or updating error handling mechanisms. Once compete, the API rescript generator 270 may store the code in a data repository, such as a code management system or other version control system (e.g., a code repository 284) to automatically create branches in the code and to fix and manage code changes. And once this is done, it will automatically initiate autonomous testing and/or validation and deployment activities, via the API certification pipeline 286, the updated API versions if validation completes successfully.

A policy enforcement layer 240 may be used to apply rules and/or security checks to monitor API functionality based on security measures, rules and/or policies associated with use of the underlying data and/or policies and regulations corresponding to enterprise operations. The policy enforcement layer may further be used with the dynamic segregation policies and/or outdating policies. For example, an outdating policy may be added to an enforcement policy rule set that establishes criteria for deprecating APIs, such as availability of newer version, providing access restriction criteria, modify the API gateway activities, and/or block all the requests to other out outdated APIs and this will block access and match the requested outdated APIs and may apply an 403 status code (e.g., a forbidden client error code) to API functionality associated with deprecated outdated APIs. As such, whenever a client application utilizes function calls from an outdated API, the applications will fail in any access attempts and will receive the 403-error message. The policy enforcement layer 240 may include a deprecation module 242 to identify outdated APIs and a deprecation warning module to identify APIs of a previous version (e.g., within a threshold number from the newest version, within a predetermined timeframe from the latest version release date, and the like). The policy enforcement layer 240 may further include a rate limiting restriction module 246 to restrict access to data from the enterprise network, such as an access rate to information accessed in successive API calls from a same source or of a same type, an access restriction module 238 and/or an access blocking module 249 to control access from API calling applications to block or restrict access based on predetermined criteria, such as API calls from unknown applications, from within restricted geographical regions, calls from suspect domains and/or computing devices or computing systems, and/or the like. Additionally, new or existing vulnerabilities may also be dynamically identified and managed by the real time threat intelligence platform and API rescript generator will automatically fix those issues and deploy it to the pipeline.

The API stratification and autonomous remediation system 104 may operate within the enterprise computing network and/or within a cloud computing environment with access rights to the enterprise computing network and operates in parallel with the API servicing applications. When the API stratification and autonomous remediation system 104 identifies an issue to be addressed within one or more APIs, and depending on the context of the API function call (e.g. whether the APIs are outdated, elevated status, critical status, and the like), the policy enforcement layer 240 determines, based off the data accessible through the API, the importance to the calling application, will dynamically and autonomously determine which policy to enforce, whether to issue a warning or restrict the number of calls allowed and access or block access to the particular API calling application, or the API itself. Further, as new threats and vulnerabilities are identified, the re-script generator adapts to automatically encode a solution and identify whether a new version of the API is necessary to resolve the issue. In some cases, the API re-script generation layer 270 may, once a new threat has been introduced, will automatically patch any affected APIs, such as to resolve any pending vulnerabilities and newly identified vulnerabilities will be automatically resolved with the newly generated code.

All learning models within the API stratification and autonomous remediation system 104 are continuously trained over time

because this real-time threat and intelligence platform receives information corresponding to new threats continuously and this information is continually aggregated into the training data set so that the system is continuously improved.

Separation of APIs and API functionality is an important challenge for enterprise network management systems. Many enterprise organizations maintain or have used numerous APIs that may require certain maintenance and/or support functionality to ensure proper and efficient operation of the enterprise network. For example, API functionality and/or API functions may require separation from others for proper operation. Further, older versions and/or outdated APIs (e.g., API for retired applications) may require retirement or other end of operational life support functionality. Because of the interpretational aspects of APIs for the application computing systems of the enterprise network, any loophole that may be missed may cause an operational and/or security vulnerability problem to the enterprise organization that may be maliciously used by attackers. Additionally, to the technical problems from API mismanagement, exposure to operational and/or security risks may also cause a loss of trust and/or other reputational loss to the organization.

As such a need for a technical solution to manage APIs and/or API libraries without any manual intervention. The application programming interface stratification and autonomous remediation system provides a reliable solution that limits security vulnerabilities to protect the enterprise network from external malicious utilization of API interfaces using machine learning and advanced data processing techniques to automate and optimize API management tasks.

The application programming interface stratification and autonomous remediation system 104 comprises several integrated components that synchronize the analysis process to analyze API documentation, an existing code base, and database logs to detect and fix issues found for any API of the enterprise network's API inventory. For example, a first component is a data ingestion layer. The data ingestion layer is responsible for collecting, reporting, and processing data from various sources. A second layer is a learning engine comprising a learning model to provide metadata schema clustering to create clusters of metadata and/or APIs based, at least in part, on data sensitivity, operational importance, and frequency of access. A third layer is an obsolete data driven API mesh that provides a hierarchical representation of parent-child dependencies for each API operational on the enterprise network based on the clustering results. A fourth layer comprises a real time threat intelligence platform that may use real time feeds to detect issues according to recently identified security threats and/or vulnerabilities and separates APIs in the API mesh. The real-time threat intelligence platform includes a security threat monitoring engine that identifies recently identified threats to maintain a security threat and/or vulnerability library that is updated in real-time with the ever-evolving attempts by malicious actors to bypass currently available and implemented security measures. As such, the real-time threat intelligence platform resolves currently identified security issues and creates fixes for additional iterations of attempts to bypass security loopholes into the API interfaces and/or to attempts to hack into the API.

The fifth layer of the application programming interface stratification and autonomous remediation system is an API re-scripting generator. The separated APIs of the API mesh are passed from the real-time threat engine to be automatically updated which the above segregated APIs which are passed from the real time threat engine to automatically update and resolve any identified issues with the APIs that require new code fixes. A policy enforcement layer may be used to identify outdated APIs and/or versions of APIs that may still be in operation or open for use. In some cases, the outdated APIs may not include all fixes for identified security vulnerabilities and/or may introduce security vulnerabilities into the enterprise network based on allowing outside applications a method to access unused or legacy functionality that may allow unintended access to the enterprise network. For example, a hacker may leverage the outdated APIs to utilize a loophole into the system. By identifying and removing such vulnerabilities, in real-time, enterprise network security is enhanced by the application programming interface stratification and autonomous remediation system.

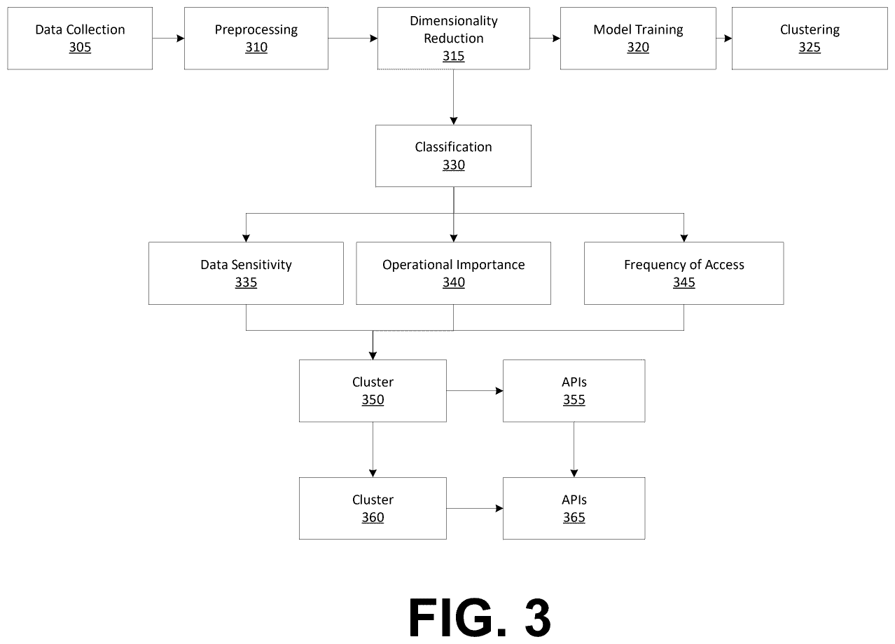

FIG. 3 shows portions of an illustrative technical flow diagram of an API stratification and autonomous remediation system in accordance with one or more aspects described herein. Here, a data ingestion process is shown first that may be used to continuously monitor data sources and aggregate the data retrieved from the data sources to allow for continuous updating of the training data set for use in training of the AI models. For example, data collection at 305 occurs continuously or periodically to allow for aggregation of data from the plurality of data sources. Preprocessing 310 occurs to format and/or otherwise ensure data will be in a correct format and/or ensure that data complies with training criteria to contain any attempted attacks that may skew results output from the AI model. Dimensionality reduction 315 may be used to further streamline the training data set before use during model training 320 and the subsequent clustering 325 of APIs and API metadata.

Further, the dimensionality reduction 315 activities may further be used to allow for efficient classification 330 of the API information to identify data sensitivity issues 335, operational importance 340 of the APIs and/or data accessed via the APIs, and/or a frequency of access 345 for each API. Using this data, the AI model may cluster the API metadata and/or APIs in clusters of metadata 350 and 360 and/or clusters of APIs 355 and 365.

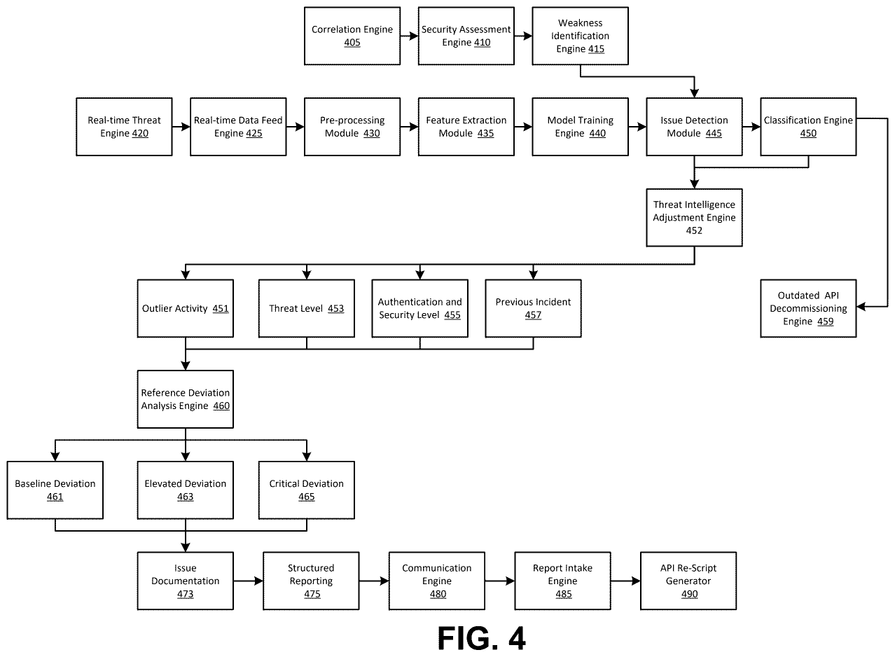

FIG. 4 shows portions of an illustrative technical flow diagram of an API stratification and autonomous remediation system in accordance with one or more aspects described herein. An issue detection module 445 may receive information from one or more sources to identify and/or classify issues or threats associated with each API operational within the enterprise computing network. For example, a correlation engine 405 may correlate data received from a plurality of sources, such as correlating security threat information and/or vulnerability information so that a security assessment engine 410 may perform a security assessment on each API, where a weakness identification engine 415 further analyzes the correlations and security assessments to output weaknesses identified for each API. The pre-processing module 430 processes the data feeds from the real-time threat engine 420 and the real-time data feed engine 425 and provides a processed aggregated data set to the feature extraction module 435 that identifies salient features of the data sets corresponding to API operations, such as reliability, success, failures, security vulnerabilities, threat vectors, and/or the like. This feature data set and the pre-processed data set is then used by the model training engine to train the AI model to identify issues with APIs, where the data output by the data model provides insight as to the API operation and threat vulnerability risk associated with each API. The classification engine 450 and the threat intelligence adjustment engine 452 then output a classification associated with each API and adjust the classification based on a risk assessment analysis of the data.

Each API may be assigned a classification by the classification engine, for example, based on a possibility that an API function or functions may be vulnerable to a particular security threat. In some cases, this risk may be adjusted, such as based on a frequency that the API function is called and/or a frequency that a problem may occur. If, for example, the risk is high, but the possibility that a vulnerability would be a risk is small, the API may be classified (and/or clustered) as an example of outlier activity 451. Similarly, the classifications may be made as to a threat level 453, authentication and/or security level 455, based on previous incidents 457, and/or the like. Additionally, outdated, or discontinued APIs, or APIs associated with a decommissioned service or application, the classification engine may initiate processing by an outdated API decommissioning engine 459. Once classified, a reference deviation analysis engine may determine whether the API corresponds to a baseline code deviation 461, an elevated code deviation 463, or a critical code deviation 465, such that an issue documentation engine 473 may store details of each issue identified with each API in an issue dataset, and a reporting engine may generate an alert, or other warning message, sent via a network to a user device associated with a user or user group responsible for network security, application maintenance and/or development, and/or the like. The reporting engine may formulate an alert message via a structured reporting engine 475 and send the alert via a communication engine 480. These reports may be structured such that a report intake engine 485 may receive an alert message and, automatically based on the information included, identify an API requiring an automated fix, an issue to be resolved, a code base to be modified, whether any relevant code templates exist, and forward such information to the API re-script generator 490 to automatically resolve the identified threat, error, or vulnerability, and autonomously test and release a new API version via a release pipeline.

A real-time threat engine 420 may continually or periodically aggregate information from one or more data sources regarding identified security threats, identified vulnerabilities, identified malicious attack patterns to provide a continuously updated threat data set. The real-time data feed engine 425 provides information corresponding to API usage and API function call information for all APIs used within an enterprise network environment.

The application programming interface stratification and autonomous remediation system passes and cleans data from API documentation, the existing code base, database logs, and analytics tools and also extracts endpoint information and/or metadata. The application programming interface stratification and autonomous remediation system further uses a machine learning model, trained on preprocessed data to create clusters of metadata and APIs based on data sensitivity, operational importance, and frequency of access.

An integral part of the application programming interface stratification and autonomous remediation system is the absolute data driven API mesh with parent-child dependencies based on the clustering results. The application programming interface stratification and autonomous remediation system employs real time threat intelligence platform learning model that uses real time fields to detect issues according to recent threats and separates APIs in the API mesh. The application programming interface stratification and autonomous remediation system utilizes the dynamic separation of APIs, by a real time threat intelligence platform, to continuously evaluate and categorize the APIs based on an evolving threat intelligence factor within the API mesh to automatically adjust security monitoring levels and/or routing decisions within the API mesh according to the current classification of each API. The application programming interface stratification and autonomous remediation system employs an API rescript generator to automatically update and fix any identified API issues that require code fixes. The application programming interface stratification and autonomous remediation system employs a policy enforcement tool for identifying outdated APIs by applying different security and/or operational policies. In doing so, the application programming interface stratification and autonomous remediation system maintains an updated and efficient inventory. In some the application programming interface stratification and autonomous remediation system seeks to enhance API management by creating a comprehensive inventory of active, limited use, and/or deprecated APIs. To do so, the application programming interface stratification and autonomous remediation system uses advanced data processing and/or machine learning techniques to analyze API documentation, user behavior, and/or access patterns to identify common use patterns for each API, where some patterns may be indicative of intended use of the API function calls and/or some patterns may indicate an attempt to bypass network security measures.

By identifying and fixing sensitive endpoints and retiring outdated versions, the application programming interface stratification and autonomous remediation system significantly reduces the possibility of data breaches and ensure compliance within regulatory standards of a well-maintained API inventory, thus streamlining and reducing computing time spent on maintaining outdated APIs. Further, the application programming interface stratification and autonomous remediation system ensures that only the most current and secure APIs are in use to provide a more reliable and faster service to users of products and/or services provided through the enterprise network functionality.

The data ingestion layer of the API stratification and autonomous remediation system may be responsible for collecting, importing, and processing data from various sources. The input sources may include an API Documentation from which the API stratification and autonomous remediation system may extract metadata and schema definitions. Further input sources may include a codebase where the API stratification and autonomous remediation system may parse code to identify API endpoints, methods, and associated data. Another input sources may be a database from which the API stratification and autonomous remediation system may access schema, tables, and data sensitivity classifications, and a logs where the API stratification and autonomous remediation system may analyze logs for API usage patterns and anomalies.

The API stratification and autonomous remediation system may include a learning model that may be used for metadata schema clustering. In doing so, the API stratification and autonomous remediation system may create clusters of metadata and APIs based on data sensitivity, operational importance, and frequency of access. The API stratification and autonomous remediation system may follow a process that may include (1) feature extraction to extract relevant features from the ingested data, clustering to group APIs based on these features, and classification to further classify the clusters depending on data sensitivity, operational importance, and frequency of access.

The API stratification and autonomous remediation system may utilize a data driven API mesh, where the API mesh may include parent-child dependencies based on the clustering results. An API Gateway may be used for managing and routing API traffic and a service mesh for managing microservices. A process may include API mesh design, where API mesh architecture may be enabled to facilitate identification of parent-child dependencies. An API registration module may be used to register APIs in the mesh according to the clustering data. A dependency module may be used to manage dependencies between APIs

The API stratification and autonomous remediation system 104 may utilize a real-time threat intelligence platform that may include a learning model that uses real-time feeds to detect issues according to recent threats and segregate APIs in the API mesh. These real-time feeds may (1) collect and aggregate logs, events, and alerts related to API usage and outlier activities and (2) integrate real-time feeds with threat intelligence platforms, such as to provide real-time data on new and emerging threats.

A feature extraction module of the API stratification and autonomous remediation system 104 may include a feature extraction module that may extract one or more features, such as (1) outlier activity that may be derived from the frequency and severity of issues detected by the threat intelligence platforms. (2) a threat level based on the current threat intelligence reports about specific types of attacks or outlier activities, (3) previous incidents that may include historical data on past incidents, breaches, or performance issues associated with the API (4) an authentication and security level that may include how security and authentication mechanisms are implemented for that API, and (5) an outdated level indication that includes API functions that no longer in use and have been replaced by newer versions.

The API stratification and autonomous remediation system 104 may perform issue detection such as to detect unusual patterns in API behavior. To do so, the API stratification and autonomous remediation system 104 may include a pattern recognition module that may recognize known patterns of issues from the threat intelligence feeds. Once an issue is detected, the system documents the specific details, the type of issue, affected endpoints and suggested fixes. Once performed, the API stratification and autonomous remediation system 104 may perform dynamic quarantine of APIs, where a real-time threat intelligence platform may continually evaluate and categorize APIs based on the latest threat intelligence adjustment factor calculations within the API mesh. The API stratification and autonomous remediation system 104 may automatically adjust security policies, monitoring levels, and routing decisions within the API mesh according to the current classification of each API. The API stratification and autonomous remediation system 104 may perform threat intelligence adjustment factor calculations by first assigning a metric to each feature based on their relevance and impact on security. For example, recent high-severity threats might be given higher weight than older, less severe incidents. Second, these features may be combined into a threat intelligence adjustment factor based on a formula, such as {Threat Intelligence Adjustment Factor}=m_1\times \text{Outlier Activity}+m_2\times\text{Threat Level}+m_3\times \text{Authentication and Security Level}+m_4\times \text{Previous Incidents} and Threat Intelligence Adjustment Factor=m1×Outlier Activity +m2×Threat Level+m3×Operational Importance+m4×Previous Incidents where m1, m2, m3, m4, m_1, m_2, m_3, and m_4 are the metrics for each feature.

The API stratification and autonomous remediation system 104 may quarantine APIs according to a reference deviation analysis. For example, the API stratification and autonomous remediation system 104 may identify and/or quarantine critical deviation APIs, such as those that require enhanced authentication, stricter access controls, and continuous monitoring. Further, the API stratification and autonomous remediation system 104 may quarantine elevated deviation APIs, such as by performing regular security checks and standard access controls. The API stratification and autonomous remediation system 104 may additionally quarantine baseline deviation APIs, such as by performing basic security measures and periodic monitoring. The API stratification and autonomous remediation system 104 may further quarantine outdated APIs that are not in user and/or are replaced with newer versions. A structured reporting engine may generate a structured report, where formats of this information may be formalized into a structured report that can easily consumed by the API re-script generator. An illustrative report may include API endpoint information, an issue type, deviated API severity information, suggested fix information, and/or the like.

The API re-script generator may utilize the above-mentioned quarantined APIs that are passed to the API re-script generator that automatically updates and fix the API issues which require code fixes. The API re-script generator may perform code analysis, such as by using custom scripts to analyze the codebase for potential issues. Code parsing functionality may parse the code to understand the structure and identify the exact location of the issues. Template-based fixes may be generated using predefined code templates to provide a framework when generating fixes for common issues. Code generation functionality may be utilized to generate more complex fixes and/or to generate new code snippets that address the identified issue. Code fixation functionality may involve changing API endpoint definitions, modifying request validation logic, or updating error handling mechanisms. A code repository may be integrated with a version control system to automatically create branches for fixes and manage code changes. CI/CD pipelines may be used to automate testing, validation, and deployment of code changes.

The API stratification and autonomous remediation system 104 may include a policy enforcement engine where, for the outdated APIs, different security and operational policies are applied. A depreciation policy may establish criteria for deprecating APIs, such as availability of newer versions. The policy enforcement engine may output deprecation warnings and may log warnings on the server side whenever an outdated API is called, indicating its deprecated status. The policy enforcement engine may utilize rate limiting restriction such as by setting one or more custom rate limiting policies for an outdated API. For example, if version 1.0 is outdated, a lower rate limit may be set. The policy enforcement engine may also perform access restriction functions, such as to modify the API gateway/service mesh configuration to block all requests to outdated APIs. This may be done by updating routing rules, ACL, or using feature flags to disable the API. Block access functionality may match requests to the outdated API and may apply a 403-status code.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A computing platform comprising:
a processor; and
memory storing computer-readable instructions that, when executed by the processor, cause the computing platform to:
receive, from a plurality of data sources, application programming interface (API) information for a plurality of APIs active on an enterprise network;
extract, by a feature extraction module from the API information, a plurality of features of each API of the plurality of APIs;
cluster, based on an analysis of the plurality of features of each API of the plurality of APIs, the API information into a plurality of API clusters;
calculate, based on metrics associated with clustering of the plurality of APIs, an adjustment factor; and
generate, automatically via code analysis scripts, code changes for each API of the plurality of APIs that meet a threshold criteria associated with a security threat; and
autonomously deploy corrected APIs via an API pipeline.

2. The computing platform of claim 1, wherein the plurality of data sources comprises an API documentation data set, an API codebase, and data logs comprising API operation information.

3. The computing platform of claim 1, wherein the plurality of API clusters comprises a first plurality of metadata clusters and a plurality of API clusters.

4. The computing platform of claim 3, wherein the clusters include parent-child relationships between APIs.

5. The computing platform of claim 1, wherein the instructions cause the computing platform to cluster the plurality of APIs based on data sensitivity information, operational importance information, and frequency of access information.

6. The computing platform of claim 1, wherein the adjustment factor is calculated as a weighted combination of API features corresponding to a relationship to network security.

7. The computing platform of claim 6, wherein the adjustment factor is calculated as a weighted combination of an outlier parameter, a threat level parameter, an authentication and security level parameter, and a previous incident parameter.

8. A method comprising:
receiving, from a plurality of data sources, application programming interface (API) information for a plurality of APIs active on an enterprise network;
extracting, by a feature extraction module from the API information, a plurality of features of each API of the plurality of APIs;
clustering, based on an analysis of the plurality of features of each API of the plurality of APIs, the API information into a plurality of API clusters;
calculating, based on metrics associated with clustering of the plurality of APIs, an adjustment factor; and
generating, automatically via code analysis scripts, code changes for each API of the plurality of APIs that meet a threshold criteria associated with a security threat; and
deploying, autonomously, corrected APIs via an API pipeline.

9. The method of claim 8, wherein the plurality of data sources comprises an API documentation data set, an API codebase, and data logs comprising API operation information.

10. The method of claim 8, wherein the plurality of API clusters comprises a first plurality of metadata clusters and a plurality of API clusters.

11. The method of claim 10, wherein the clusters include parent-child relationships between APIs.

12. The method of claim 8, further comprising clustering the plurality of APIs based on data sensitivity information, operational importance information, and frequency of access information.

13. The method of claim 8, wherein the adjustment factor is calculated as a weighted combination of API features corresponding to a relationship to network security.

14. The method of claim 13, wherein the adjustment factor is calculated as a weighted combination of an outlier parameter, a threat level parameter, an authentication and security level parameter, and a previous incident parameter.

15. Non-transitory computer readable media storing instructions that, when executed by a processor, cause a computing platform to:
receive, from a plurality of data sources, application programming interface (API) information for a plurality of APIs active on an enterprise network;
extract, by a feature extraction module from the API information, a plurality of features of each API of the plurality of APIs;
cluster, based on an analysis of the plurality of features of each API of the plurality of APIs, the API information into a plurality of API clusters;
calculate, based on metrics associated with clustering of the plurality of APIs, an adjustment factor; and
generate, automatically via code analysis scripts, code changes for each API of the plurality of APIs that meet a threshold criteria associated with a security threat; and
autonomously deploy corrected APIs via an API pipeline.

16. The non-transitory computer-readable media of claim 15, wherein the plurality of data sources comprises an API documentation data set, an API codebase, and data logs comprising API operation information.

17. The non-transitory computer-readable media of claim 15, wherein the plurality of API clusters comprises a first plurality of metadata clusters and a plurality of API clusters.

18. The non-transitory computer-readable media of claim 17, wherein the clusters include parent-child relationships between APIs.

19. The non-transitory computer-readable media of claim 15, wherein the instructions cause the computing platform to cluster the plurality of APIs based on data sensitivity information, operational importance information, and frequency of access information.

20. The non-transitory computer-readable media of claim 15, wherein the adjustment factor is calculated as a weighted combination of API features corresponding to a relationship to network security.
